(19) United States
(12) Patent Application Publication
(10) Pub. No.: US 2016/0229257 A1
(43) Pub. Date: Aug. 11, 2016

(54) VEHICLE AND VEHICLE CABIN AIR EXTRACTION SYSTEM

(71) Applicant: FORD GLOBAL TECHNOLOGIES, LLC, DEARBORN, MI (US)

(72) Inventors: Eric R. YERKE, Redford, MI (US); Paul Bryan HOKE, Plymouth, MI (US); Frank FUSCO, Plymouth, MI (US); Robert Steven SAWYER, Farmington Hills, MI (US)

(21) Appl. No.: 14/618,616

(22) Filed: Feb. 10, 2015

(51) Int. Cl. B60H 1/00; B60H 1/24

(52) U.S. Cl. CPC B60H 1/008; B60H 1/00864; B60H 1/248

(57) ABSTRACT

A vehicle is provided. The vehicle includes an air extraction outlet located on an interior panel that partially defines an interior cabin of the vehicle. The air extraction outlet has a series of vanes that are configured to transition between open and closed positions. An actuator is utilized to transition the series of vanes between the open and closed positions. The air extraction outlet is configured to exhaust air from the cabin of the vehicle when the vanes are in the open position. The vehicle also includes a sensor and a controller. The controller is programmed to activate the actuator in order to transition the vanes between the open and closed positions based on a condition of the sensor.

### TECHNICAL FIELD

The present disclosure relates to air extraction systems for vehicles.

### BACKGROUND

To permit air to flow from the passenger compartment of a vehicle to the ambient air surrounding the vehicle exterior, vehicles may include air extractors in the interior of the vehicle.

### SUMMARY

A vehicle is provided. The vehicle includes an air extraction outlet located on an interior panel that partially defines an interior cabin of the vehicle. The air extraction outlet has a series of vanes that are configured to transition between open and closed positions. An actuator is utilized to transition the series of vanes between the open and closed positions. The air extraction outlet is configured to exhaust air from the cabin of the vehicle when the vanes are in the open position. The vehicle also includes a sensor and a controller. The controller is programmed to activate the actuator in order to transition the vanes between the open and closed positions based on a condition of the sensor.

A vehicle is provided. The vehicle includes a package tray that partially defines an interior cabin of the vehicle. An air extraction outlet is located on the package tray. The air extraction outlet has articulating vanes that are configured to exhaust air from the vehicle cabin when in an open position and obstruct a line of sight into an interior of the air extraction outlet when in a closed position. An actuator is configured to transition the articulating vanes between the open and closed positions. The vehicle also includes a sensor and a controller. The controller is programmed to activate the actuator in order to transition the articulating vanes between the open and closed positions based on a condition of the sensor.

A method of operating an air extraction system in a vehicle is provided. The method includes activating an actuator to transition articulating vanes of an air extraction outlet between open and closed positons, in response to a sensed condition of a cabin of the vehicle, to selectively exhaust air from the cabin. The air extractor outlet may be located on a panel partially defining the cabin of the vehicle.

### BRIEF DESCRIPTION OF THE DRAWINGS

FIG. 1 is a schematic illustration of a vehicle having air extractor outlets that are in open positions;

FIG. 2 is a schematic illustration of a vehicle having air extractor outlets that are in closed positions; and

FIG. 3 is a flowchart illustrating a method of operating an air extraction system of a vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

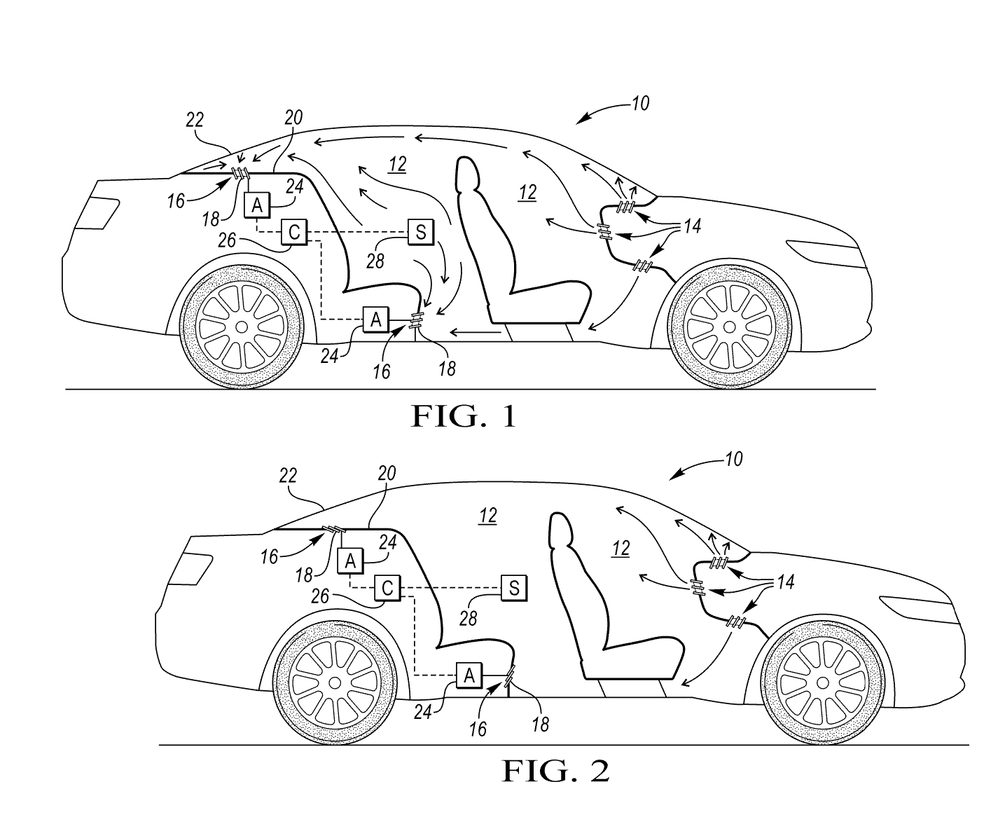

Referring to FIGS. 1 and 2, a vehicle 10 is illustrated. The vehicle 10 may include a heating, ventilating, and air conditioning (HVAC) system for the vehicle interior (also known as the vehicle cabin 12). The HVAC system may include a series of inlets 14 that deliver air to the vehicle cabin 12. The air being delivered through the series of inlets 14 may or may not be heated or cooled before being delivered into the vehicle cabin 12. The air entering the vehicle cabin 12 may be heated by a heating system that transfers heat from the vehicle's engine coolant to the air being introduced to the vehicle cabin 12 through a heat exchanger, such as a heater core. The air entering the vehicle cabin 12 may be cooled by an air conditioning system that utilizes a refrigerant to extract heat from the air being introduced to the vehicle cabin 12. The air conditioning system may include a compressor, a condenser, an expansion valve, an evaporator, a drier, or other components that are typical to air conditioning systems.

Air extraction outlets 16 may be utilized to exhaust air from the vehicle cabin 12 to the surrounding environment. The air extraction outlets 16 may be connected to a series of ducts or channels that direct the extracted air to the surrounding environment. The air extraction outlets 16 may include a series of articulating vanes 18 that transition between an open position and a closed position. The articulating vanes 18 may also be referred to as baffles or louvers. The articulating vanes 18 are shown in the open position in FIG. 1 and in the closed position in FIG. 2. The articulating vanes 18 of each air extraction outlet 16 may be connected by a series of mechanical links and the articulating vanes may each pivot about an axis to transition between the open and closed positions. The articulating vanes may also include partially opened positions between a fully opened position and a fully closed position.

Each air extraction outlet 16 may be connected to an interior component of the vehicle 10, such as an interior trim component or panel. More specifically it may be desirable to place an air extraction outlet 16 on a tray package 20 or an interior trim component that is located adjacent to a window 22 of the vehicle 10. A package tray is an interior trim component that is located below the rear window, above the trunk area, and behind the rear passenger seats. The articulating vanes 18 of an air extraction outlet 16 that is located adjacent to a window 22 may be angled to draw air away from the window 22 when in the open position, which may assist in defogging the window 22 by drawing the heavier moist air out of the cabin 12.

The articulating vanes 18 of the air extraction outlet 16 are configured to block sight lines into an interior of the air extraction outlet 16 when in the closed position. The air extraction outlet 16 may include a series of frames or recesses that each vane 18 recedes into in order to block sight lines into the interior of the air extraction outlet 16 when in the closed position. In the alternative, the articulating vanes 18 may be overlapped or shingled in order to the block sight lines when in the closed position.

Actuators 24 may be linked or connected to the articulating vanes in order to transition the articulating vanes 18 between the open and closed positions. The actuators 24 may be pneumatic or hydraulic cylinders; motors, including electric and servo motors; electric solenoids or any other device that is capable linking to and transitioning the articulating vanes 18 between the open and closed positions.

The actuators 24 may be connected to a controller 26 that is configured to activate the actuators 24 in order to transition the articulating vanes 18 between the closed and open positions depending on a condition in the vehicle cabin 12. The condition of the vehicle cabin 12 may be detected by a sensor 28. The sensor 28 may be attached to interior portion of the vehicle 10 and in any position where the sensor 28 is capable of obtaining an accurate measurement of the condition in the vehicle cabin 12. The condition of the vehicle cabin 12 may be a cabin pressure, cabin humidity, carbon monoxide content in the vehicle cabin, carbon dioxide content in the vehicle cabin, NOₓ gas content in the vehicle cabin (including nitric oxide and nitrogen dioxide), hydrocarbon content in the vehicle cabin (including gasoline fumes), or any other factor inside the vehicle cabin 12 that may contribute to a passenger's comfort, health, or safety.

Although two air extraction outlets 16 and one sensor 28 are depicted in FIGS. 1 and 2, the vehicle 10 may include one or more air extraction outlets 16 and one or more sensors 28. In systems that include more than one air extraction outlets 16 and sensors 28, the vehicle 10 may also be divided into zones. For example, the vehicle 10 may include front, middle, and rear zones or left side and right side zones. In vehicles 10 that include zones, the multiple air extraction outlets 16 may be operated and controlled independently of each other. For example, if the condition of the vehicle cabin 12 has exceeded a threshold in a first zone but not in a second zone, an air extraction outlet 16 designated to the first zone may be opened while an air extraction outlet 16 in the second zone may be closed.

Furthermore, the system may include sensors 28 configured to detect one or several of the vehicle cabin 12 conditions. Individual sensors 28 may be configured to detect several of the vehicle cabin 12 conditions, or multiple individual sensors that each detects only one of the vehicle cabin 12 conditions may be utilized. Air extraction outlets 16 may be configured to open when any of one of the vehicle cabin 12 conditions exceeds a threshold.

While illustrated as one controller, the controller 26 may be part of a larger control system and may be controlled by various other controllers throughout the vehicle 10, such as a vehicle system controller (VSC). It should therefore be understood that the controller 26 and one or more other controllers can collectively be referred to as a “controller” that controls various actuators in response to signals from various sensors to control functions. The controller 26 may include one or more microprocessors or central processing units (CPUs) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 26 in controlling the vehicle 10.

In the absence of an actuator, the articulating vanes 18 may include springs or dampers that allow the articulating vanes 18 to transition from the closed position to the open position when the pressure difference between each side of the air extraction outlet 16 surpasses a threshold. When the pressure difference returns to a value below the threshold, the springs or dampers may return the articulating vanes 18 to the closed position.

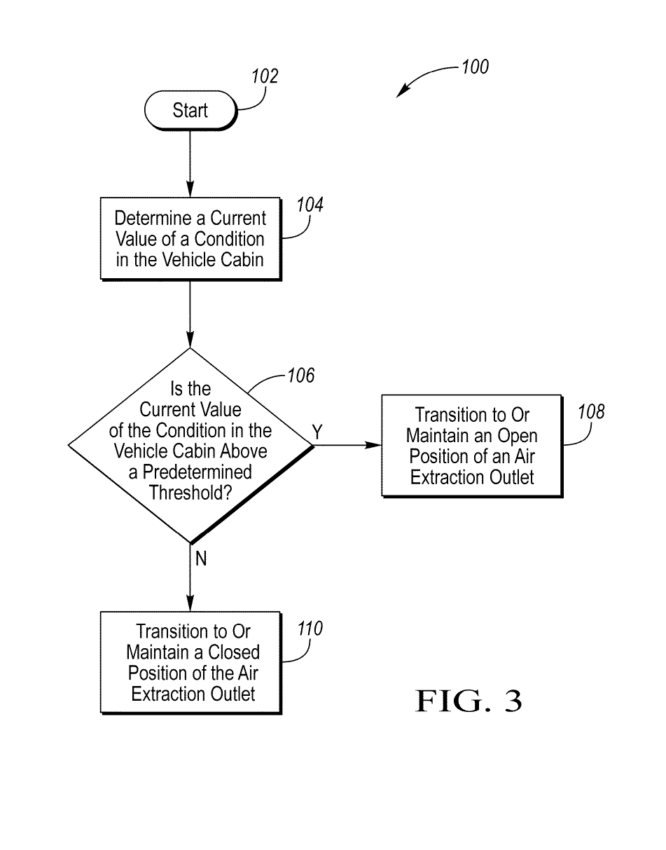

Referring now to FIG. 3, a method 100 of operating an air extraction system of the vehicle 10 is illustrated. The method may include operating one or several air extraction outlets 16 that may or may not be divided into zones. Multiple air extraction outlets may operate independently depending on a vehicle cabin 12 condition specific to each zone of the vehicle cabin 12, as described above.

The method starts at step 102. The method may be initiated by simply turning on the ignition switch of the vehicle, starting the engine, turning on the vehicle's HVAC system, or during any period when monitoring the vehicle cabin 12 may be appropriate.

The method 100 then moves on to step 104 where a current value of a vehicle cabin 12 condition is determined. The vehicle condition may include one or more of any of the conditions listed above or any other factor inside the vehicle cabin 12 that may contribute to the passenger's comfort, health, or safety. The vehicle cabin 12 condition may be detected by one or more sensors, as described above.

The method 100 then moves to step 106 where it is determined if the current value of the vehicle cabin 12 condition is above a predetermined threshold. If the vehicle cabin 12 condition is above the predetermined threshold, the method moves to step 108 where an air extraction outlet 16 is either transitioned to or maintained in the open position. If the vehicle cabin 12 condition is below the predetermined threshold, the method moves to step 110 where an air extraction outlet 16 is either transitioned to or maintained in the closed position. The air extraction outlet 16 may be specific to a zone in systems that include multiple air extraction outlets 16.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
an air extraction outlet on a panel partially defining a cabin of the vehicle, having vanes configured to transition between open and closed positions via an actuator, and configured to exhaust air from the cabin when the vanes are in the open position;
a sensor; and
a controller programmed to activate the actuator to transition the vanes between the open and closed positions based on a condition of the sensor.

2. The vehicle of claim 1, wherein the vanes are further configured to obstruct a line of sight into an interior of the air extraction outlet when in the closed position.

3. The vehicle of claim 1, wherein the sensor is a pressure sensor and the condition corresponds to a cabin pressure of the vehicle.

4. The vehicle of claim 1, wherein the sensor is a humidity sensor and the condition corresponds to a cabin humidity of the vehicle.

5. The vehicle of claim 1, wherein the sensor is a carbon monoxide gas sensor and the condition corresponds to a cabin carbon monoxide content of the vehicle.

6. The vehicle of claim 1, wherein the sensor is a NOₓ gas sensor and the condition corresponds to a cabin NO content of the vehicle.

7. The vehicle of claim 1, wherein the actuator is a pneumatic cylinder.

8. The vehicle of claim 1, wherein the actuator is an electric motor.

9. The vehicle of claim 1, wherein the air extraction outlet is positioned adjacent to a window of the vehicle and the open position permits the air extraction outlet to draw air away from the window.

10. The vehicle of claim 1, wherein the panel is a package tray.

11. A vehicle comprising:
a package tray partially defining a cabin of the vehicle;
an air extraction outlet on the package tray having articulating vanes configured to exhaust air from the vehicle cabin when in an open position and obstruct a line of sight into an interior of the air extraction outlet when in a closed position;
an actuator configured to transition the articulating vanes between the open and closed positions;
a sensor; and
a controller programmed to activate the actuator to transition the articulating vanes between the open and closed positions based on a condition of the sensor.

12. The vehicle of claim 11, wherein the sensor is a pressure sensor and the condition corresponds to a cabin pressure of the vehicle.

13. The vehicle of claim 11, wherein the sensor is a humidity sensor and the condition corresponds to a cabin humidity of the vehicle.

14. The vehicle of claim 11, wherein the sensor is a carbon monoxide gas sensor and the condition corresponds to a cabin carbon monoxide content of the vehicle.

15. The vehicle of claim 11, wherein the sensor is a NOₓ gas sensor and the condition corresponds to a cabin NOₓ content of the vehicle.

16. A method of operating an air extraction system in a vehicle comprising:
activating an actuator to transition articulating vanes of an air extraction outlet located on a panel partially defining a cabin of the vehicle between open and closed positons in response to a sensed condition of the cabin to selectively exhaust air from the cabin.

17. The method of claim 16, wherein the sensed condition is a pressure in the cabin.

18. The method of claim 16, wherein the sensed condition is a humidity level in the cabin.

19. The method of claim 16, wherein the sensed condition is a carbon monoxide gas content in the cabin.

20. The method of claim 16, wherein the sensed condition is a NOₓ gas content in the cabin.
